(19) United States
(12) Patent Application Publication
(10) Pub. No.: US 2004/0256059 A1
(43) Pub. Date: Dec. 23, 2004

(54) Evaporators background to the invention

(76) Inventors: Richard Selwyn Jebson, Palmerston (NZ); Hong Chen, Hamilton (NZ)

Correspondence Address: YOUNG & THOMPSON, 745 SOUTH 23RD STREET, 2ND FLOOR, ARLINGTON, VA, 22202, US

(21) Appl. No.: 10/493,598

(22) PCT Filed: Oct. 25, 2002
(86) PCT No.: PCT/NZ02/00224

(30) Foreign Application Priority Data
Oct. 26, 2001 (NZ) 515074

(51) Int. Cl. B01D 1/22; B01D 1/00

(52) U.S. Cl. 159/6.1; 159/43.1; 159/44

(57) ABSTRACT

An evaporator particularly useful for milk evaporation. The evaporator includes a rotor (12) within steam chamber (11) of housing (10). Liquid feed passes through conduit (13) to emit through outlets (14) and (15) onto the inner periphery of evaporator surfaces (16) and (17) of cone pairs (C, C₁) and (C₂). Concentrate can flow between cone pairs via tubes (22) at the other periphery of the cone pairs. Concentrate is picked up at cone pair (C₂) and the lowermost cone pair (C₁) to flow through outlet conduit (30). The cone angle of each cone is in the range of 5° to 45° preferably about 10°.

### BACKGROUND TO THE INVENTION

This invention relates to improvements in evaporation apparatus and in particular an evaporator having particular application for milk evaporation.

High heat transfer coefficients are required in an evaporation process carried out in an evaporator in order to reduce the surface area and cost of the equipment. One known method employed to increase heat transfer coefficients in evaporators is to make the evaporating surface of a conical shape and then rotate the cone about its axis. According to such method, steep cone angles have been used. For example, there is known the Centritherm evaporator of Alfa Laval which is based on a rotating cone machine having a high heat transfer coefficient (in the order of 7 kw/m²C) and a very short residence time. In the Centritherm evaporator the cone angle is about 60°.

A problem which exists with cones is that as the evaporating liquid moves down the surface of the cone the area increases and necessarily the film thickness must decrease. This problem is accentuated by the evaporation of a portion of the liquid which will further decrease the film thickness.

For the evaporation of milk or other sensitive liquids the temperature of evaporation is important. The higher the temperature the greater the degree of pasteurisation and the higher the heat transfer coefficient, but the greater the denaturation of proteins and the less suitable the milk is for some products e.g. some cheeses or soluble whey proteins or low heat skim milk powders.

Many evaporators cannot handle highly viscous products, but there is a need at times to concentrate liquids to a stage where their viscosity is high. In the design of evaporators for concentrating milk, low shear rates must be achieved in order to minimise the break up of fat globules.

### SUMMARY OF THE INVENTION

It is thus an object of the present invention to provide an evaporator which is particularly suitable for evaporation of milk, but is also suitable for other liquids, the type of evaporator overcoming or going some way to overcoming the problems identified above.

According to the present invention in one broad aspect there is provided an evaporator including at least one rotatable cone characterised in that the cone has an evaporation surface which is disposed radially at a shallow angle to the axis of rotation of the cone.

Preferably the evaporation surface of the cone is at an angle of between substantially 5° and 45°, preferably 10°.

The shallow angle and high speed rotation provides high centrifugal forces, which enables viscous liquids to be handled more easily than in other types of evaporators. The high centrifugal forces cause the liquid film to pass over the evaporation surface very quickly giving short holding times in the evaporator.

In the preferred form the liquid is applied to the cone at or near the inner edge portion of the cone from pipes angled so that the liquid flows tangentially from the pipe outlet to the cone surface. Preferably the pipe outlet diameter should be such that the liquid emits at the velocity of the cone at that point. The liquid can be applied from a conduit having an outlet end away from the direction of angular rotation of the cone.

According to one form of the invention there is provided a plurality of cones. Preferably there is provided transfer means for transfer of liquid from one pair of cones to another.

The evaporator further includes outlet means. In a preferred form the outlet means can be a conduit having an inlet end located adjacent a peripheral edge portion of the or one of the cones. The outlet preferably is located facing the direction of angular rotation of the cone and is tangential thereto.

### BRIEF DESCRIPTION OF THE DRAWINGS

In the following more detailed description of the invention reference will be made to the accompanying drawings in which:

FIG. 1 is a largely schematic illustration of an evaporator according to the present invention,

FIG. 2 is an elevation view of an evaporator apparatus incorporating one embodiment of the invention,

FIG. 3 is a section on line A-A of FIG. 2,

FIG. 4 is a plan view of the evaporator apparatus of FIG. 2,

FIG. 5 is an elevation view of the evaporator rotor of the embodiment of FIGS. 2, 3 and 4,

FIG. 6 is a section taken on line D-D of FIG. 5,

FIG. 7 is a section taken on line B-B of FIG. 5,

FIG. 8 is a section taken on line C-C of FIG. 5,

FIG. 9 is a diagram of a farm evaporator system incorporating the evaporator of the present invention,

FIG. 10 is a diagram of a mechanical system of farm evaporation employing the evaporator of the present invention and the evaporator system as illustrated by FIG. 9, and

FIG. 11 is a schematic illustration of a further embodiment of evaporation apparatus incorporating the present invention.

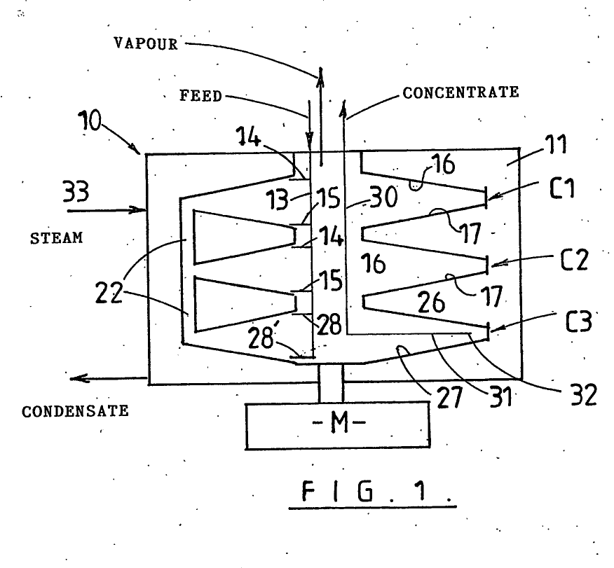

Referring firstly to FIG. 1, the present invention is based on an evaporator having a low or shallow cone angle such as 10°. It has been somewhat unexpectedly found-that a 10° cone performs very well for the evaporation of milk and water and with very high heat transfer coefficients. It is, however, believed that the advantages of the present invention will be achieved with evaporators having a cone angle in the range of 5°-45°. This includes cones where the cone has a variable angle, a section of the cone having a parabolic or other curved shape. Such variable angle sections may be easier to construct.

FIG. 1 shows the evaporator in a single stage construction largely in schematic form. According to the arrangement shown there is a housing 10.

Mounted within the interior 11 of the housing 10 and rotatable therein is a rotor 12. This rotor 12 is constructed to form a plurality of cones in parallel or pairs shown generally as cone pairs C. There are thus three cone pairs.

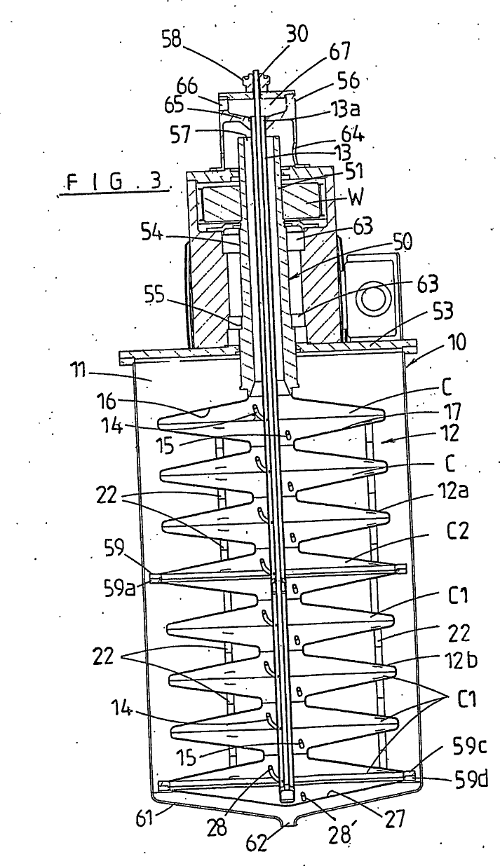

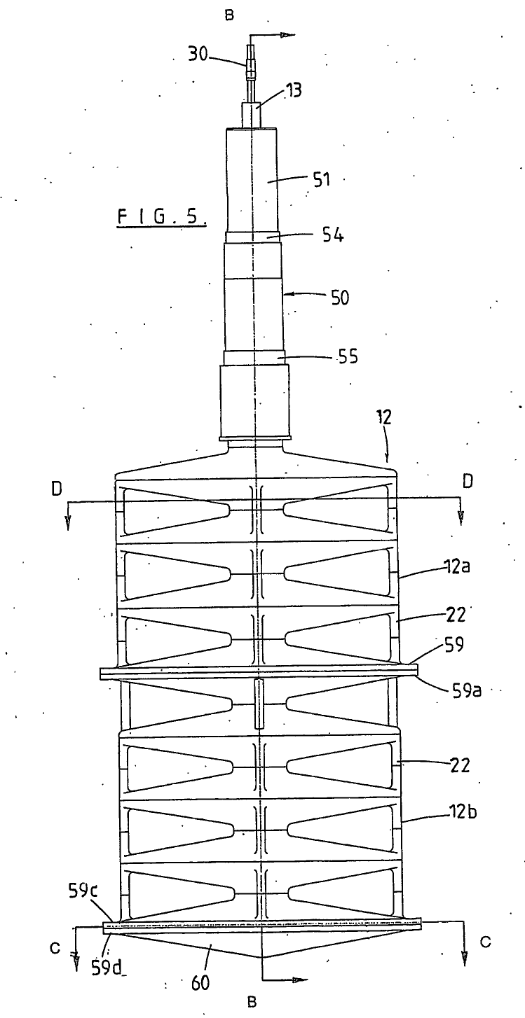

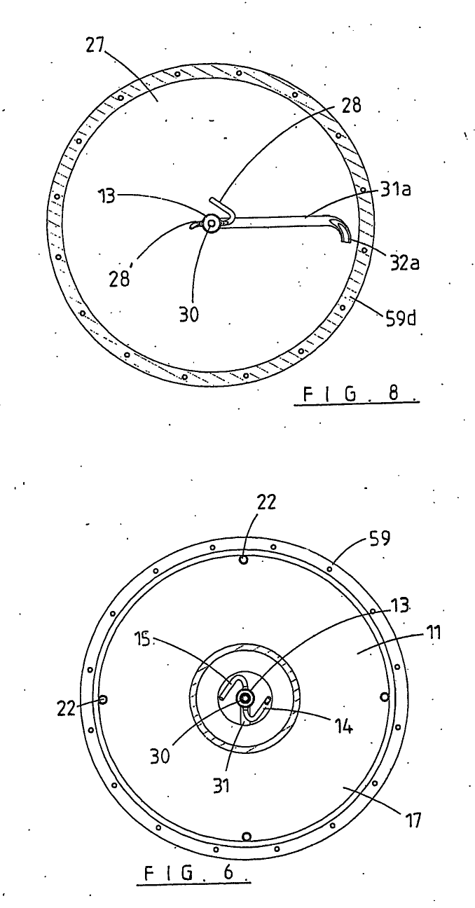

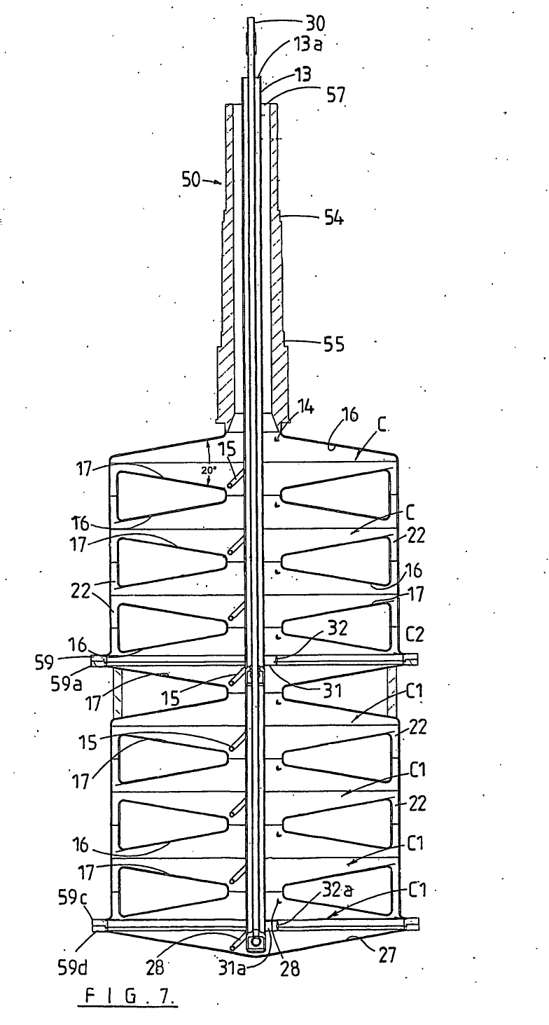

It will be appreciated by those skilled in the art that more or less cones can be incorporated (see e.g. FIGS. 3, 5, 6 and 11) as may be deemed necessary for the end purpose. As mentioned above, the cone angle is in the order of 10° from the horizontal i.e. 20° between the cone surfaces as shown, for example, at the top left hand corner of the rotor 12 illustrated in FIG. 7.

A feed pipe 13 extends downwardly within the centre of the rotor 12. This feed pipe 13 has an outlet 14 and 15 in the form of deposit tubes located adjacent the respective evaporation surfaces 16 and 17 of each of the cone pairs C.

The feed pipe 13 is fixed in position, thus liquid e.g. milk can be supplied into the feed pipe 13 to issue through the outlets 14 and 15 near the inner peripheral edge of the respective cone pairs C. These outlets face “downstream” i.e. in the direction of angular rotation of the cones. Milk at high velocity enters the pipe 13 and is thus directed onto the surfaces 16 and 17 of the respective cone pairs C and near the centre of the cones.

According to a preferred form, the outlets 14 and 15 can be formed as or incorporate nozzles. The nozzles are preferably of a type which not only ensures even distribution onto the cone evaporation surface but also provides a pressure drop across the nozzle so as to achieve feed onto the cone surface at, or substantially at, the speed of the cone.

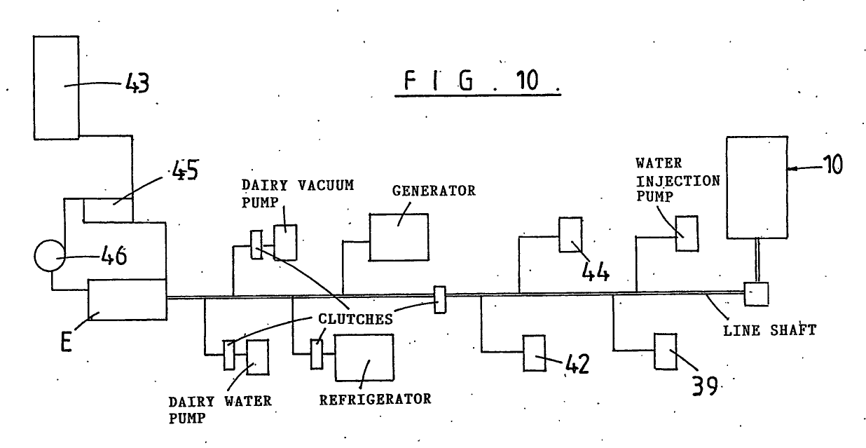

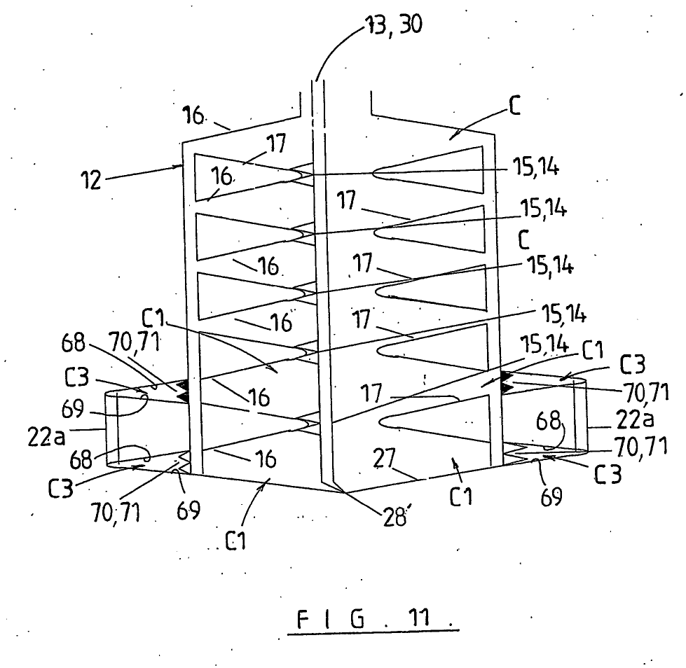

A number of such pipes 13 can be used to direct the liquid to be evaporated over as many conical surfaces as is necessary to effect the evaporation. The arrangement shown in FIG. 1 is therefore by way of example only. Thus, it is possible to have an arrangement such as shown in FIG. 10 which will be described hereinafter.

At the earlier stages of evaporation the pairs of cones C may be used in parallel with pipes or conduits 22 at the periphery of the cones carrying the liquid vertically downwards to the next cone pair. Thus, at the outer peripheral edge of the cone pairs C there is a plurality of connecting pipes 22 whereby liquid from an upper cone pair C can pass downwardly to the next cone pair C.

In a two stage arrangement a pickup inlet can be located adjacent to the outer peripheral portion of the surface of second cone pair, the pickup inlet being located substantially tangentially to the surface and facing opposite the direction of angular rotation of the cones.

A transfer pipe (not shown) can extend from the pickup inlet and pass centrally down to the lowermost cone pair C. This pipe will have an outlet end which is located adjacent the centre of the lowermost cone while an outlet from the transfer pipe is located adjacent the inner edge of the surface of upper cone of the lowermost cone pair.

However, in the illustrated one stage arrangement of FIG. 1 the cone pairs C are joined by connecting pipe(s) 22 while feedpipe 13 has outlets 28 and 28′ positioned adjacent the inner ends of surfaces 26 and 27 of the lowermost cone pair C.

Also extending centrally down between the cones pairs C and fixed in position is a concentrate pipe 30. This has a lower-most portion 31 which extends within the lowermost cone pair C and has an inlet 32 which is positioned adjacent the surface 27 of the lower cone in the lowermost cone pair C. This inlet end 32 is located tangentially and facing opposite the direction of rotation of the cones. The inlet 32 is sized so that the velocity of the entry of concentrate into the pipe 31 will be similar to the angular velocity of the rotating concentrate.

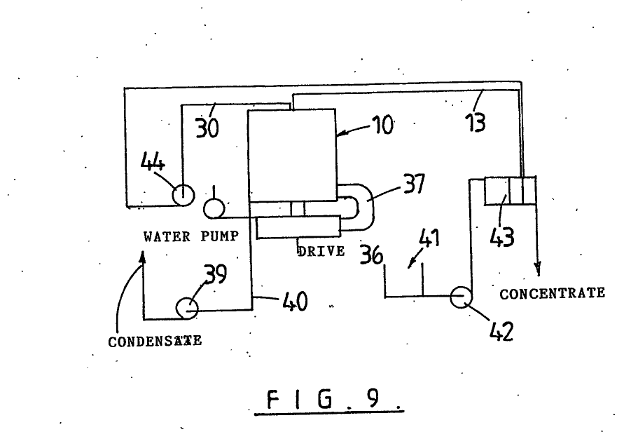

Thus, concentrate enters pipe 31 via inlet 32 to travel along the concentrate pipe 30 to a point outside the housing 10. The outlet pipe 31 is shaped so that there is a smooth transition in velocity to that of the concentrate entering concentrate pump 44 (see FIG. 9).

The housing 10 has a steam inlet 33. This inlet 33 enables steam to be fed into the steam chamber 11.

The vapours arising from the evaporation process will be rotating. The vapours thus pass into a central tube 34 to exit through outlet 35. The vapours then pass from there to a centripetal fan 36 (see FIG. 9) by which they are partly compressed. A transfer pipe 37, as shown in FIG. 9, connects the vapour outlet 35 to the fan 36.

The partly compressed vapours then pass to a second (rotating) fan which may, but need not be, mounted on the same shaft as the rotating cone pairs C. The second fan further compresses the vapours which then pass to the steam side of the rotating cones. The vapours are condensed by some suitable means and the condensate pumped out of the evaporator.

As shown in FIG. 9, the condensate is drawn from the evaporator 10 by pump 39 coupled by conduit 40 to the drainage openings of housing 10. Condensate from outer surface areas of the cones is rotating. It is taken out of the steam chamber 11 by a pipe tangential to the chamber walls and facing downstream to the rotating condensate.

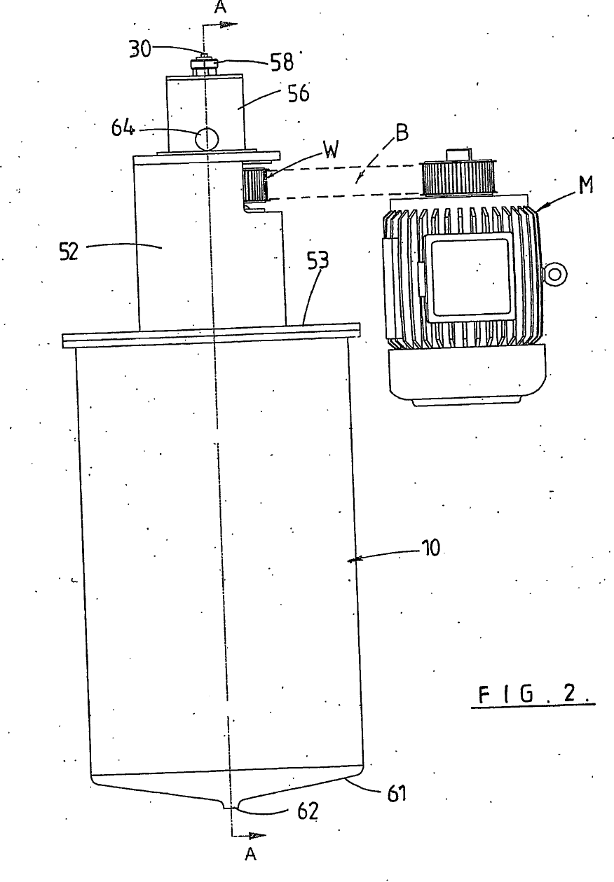

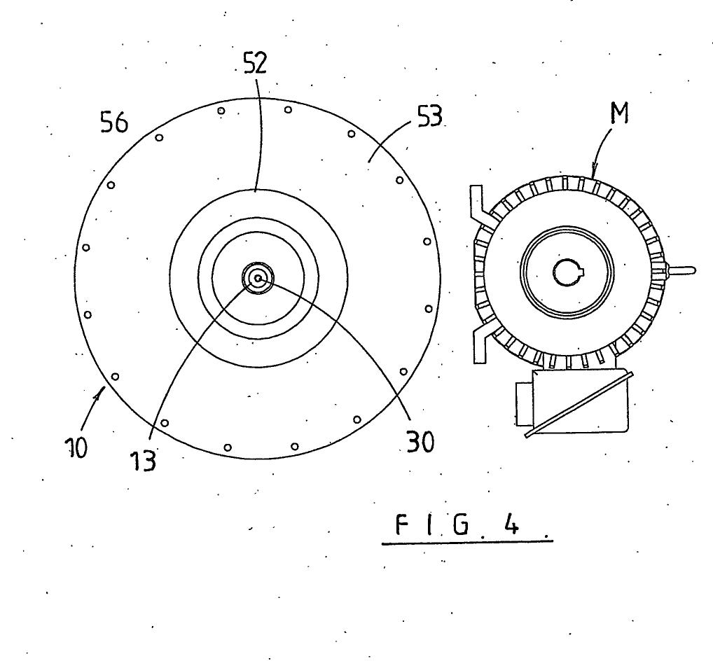

A more detailed illustration of evaporator apparatus incorporating the present invention but in a two stage configuration is shown in FIGS. 2-8. For ease of description this version of the evaporator apparatus carries the same reference numerals as that used in relation to the schematic illustration of FIG. 1.

In this version drive to the rotor 12 is applied by motor M which is connected by a drive belt B to a drive wheel W fixedly attached to stepped portion 51 of shaft 50 of the rotor 12. This shaft 12 is located within housing 52 which projects upwardly from the top plate 53 of the housing 10. Bearings 63 engage with stepped portions 54 and 55 of the shaft 50 for rotational mounting of the shaft and hence the rotor 12.

The shaft 50 is hollow as shown e.g. in FIGS. 3 and 7. Through this shaft 50 passes the feed pipe 13 within which is concentrically mounted the concentrate pipe 30. The upper end of the shaft 50 is located within a cover portion 56. The open end 57 of hollow shaft 50 through which the water vapour transfers from the housing 10 is able to exhaust through outlet 64 in the housing 56.

Housing 56 also carries an external support 58 and an internal support 65 for support of the pipes 13 and 30. In the arrangement, as illustrated, an inlet 66 is formed near the upper end of housing 56 for connection of a milk line or conduit so that milk can flow therethrough into a chamber 67 and thence into the open end 13a of feed pipe 13.

As shown in this form of the invention there are further cone pair C in the first stage in upper rotor section 12a. The second stage is formed by additional pairs C₁ located in a bottom rotor section 12b. Effectively a cone pair C₂ is formed at the join of the top and bottom rotor sections 12a and 12b.

The rotor sections 12a and 12b are coupled together by interfitting flanges 59 and 59a. In a similar manner flanges 59c and 59d enable a bottom disc 60 to be attached to form the bottom of the rotor 12 as well as surface 27 of the lower cone of the lowermost cone pair C₁.

At each of the flanged couplings there is provided a pickup tube 31 and 31a with inlets 32 and 32a respectively for each stage. Thus concentrate flowing to the area formed by interfitting flanges 59/59aand 59c/59d is picked up by pickup tubes 31 and 31a respectively and flows into concentrate pipe 30.

The bottom wall 61 of housing 10 has an outlet 62 for condensate.

In an on-farm evaporation system as shown schematically in FIG. 8, milk from the milking machine (not shown) is pumped through a cooling heat exchanger (not shown) to a holding tank 41. The use of a holding tank overcomes imbalances in the rate of milking and the rate of evaporation. Milk from the holding tank then passes through a heat exchanger 43 where it may be heated by the concentrated milk, and/or the condensate and/or hot water to at least the evaporation temperature. The milk then enters the evaporator 10 via feed pipe either through a variable speed positive pump or through a control valve and/or a centrifugal pump.

As shown in FIG. 9, the evaporator 10, fans and pumps may be either electrically driven or their power needs can be supplied by a diesel or other fossil fuelled engine. In the latter case, for on-farm milk evaporation, hot water from the engine jacket of engine E may pass through a heat exchanger 45 by pump 46 to a hot water storage 47. The hot water can be used as a hot water supply for the dairy and for starting and cleaning the evaporator 10.

The power input required to drive the evaporator 10, the milking machine, the refrigerator, water pumps and pumps forming part of the farm evaporation system, and a generator to supply electricity for lighting or all or any of the other power requirements, can all be derived from engine E.

The evaporator can thus form part of an on-farm evaporation system which is efficient to operate and will provide on-farm savings.

The invention is open to modification as will be apparent to those skilled in the art. For example, as indicated previously, a multiplicity of conical surfaces can be provided as may be necessary to effect the evaporation. A further such arrangement is shown in FIG. 11 where certain of the surfaces of cone pairs can effectively be extended. Thus, in the arrangement in FIG. 11 there are six cone pairs but with the lowermost pairs C₁ being extended into extended cone pairs C₃ with surfaces 68 and 69. Nozzles 70 and 71 can thus direct flow of concentrate along the extended surfaces into tubes 22a such that the final concentrate passes down these tubes 22a to be extracted in a similar manner to the arrangement previously described, although the extraction pipe is not shown in FIG. 11.

Other modifications within the scope and spirit of the present invention will be apparent to those skilled in the art.

The present invention thus provides an evaporator having a number of shallow rotating cones as its evaporating surface giving a high capacity and short residence time. Preferably there are one or more cone pairs fed in parallel and/or series as suits best the flow and evaporation requirements of the particular application.

Because the evaporator has a very short holding time it is eminently suitable for concentrating heat sensitive liquids.

1-23. (cancelled).

24. An evaporator including at least one cone rotatable about the longitudinal axis of the cone, characterised in that the cone has an evaporation surface which is disposed radially at a shallow angle relative to the axis of rotation of the cone.

25. The evaporator as claimed in claim 24 wherein the evaporation surface of the cone is at an angle of between substantially 5° and 45°.

26. The evaporator as claimed in claim 24 wherein the cone angle is substantially 20°.

27. The evaporator as claimed in claim 24 including supply means to supply the liquid to the cone at or near the inner edge portion of the cone.

28. The evaporator as claimed in claim 27 wherein the supply means includes an outlet angled so that the liquid flows tangentially therefrom to the cone surface.

29. The evaporator as claimed in claim 28 wherein the outlet has a cross-sectional area such that the liquid emits from the outlet at the velocity of the cone at that point.

30. The evaporator as claimed in claim 28 wherein the outlet is directed away from the direction of angular rotation of the cone.

31. The evaporator as claimed in claim 29 wherein there is a plurality of cones.

32. The evaporator as claimed in claim 31 wherein the plurality of cones are arranged in opposing pairs of cones.

33. The evaporator as claimed in claim 32 wherein there is provided transfer means for transfer of liquid from one pair of cones to another.

34. The evaporator as claimed in claim 31 further including outlet means for the or each cone.

35. The evaporator as claimed in claim 34 wherein the outlet means is a conduit having an inlet end located adjacent a peripheral edge portion of the cones.

36. The evaporator as claimed in claim 35 wherein the outlet is located facing the direction of angular rotation of the cone and is tangential thereto.

37. The evaporator as claimed in claim 31 wherein there is a rotor formed from a plurality of cones, the rotor being mounted for rotation, said rotor including an axially extending liquid feed conduit and an axially extending concentrate conduit.

38. The evaporator as claimed in claim 37 wherein the liquid feed and concentrate conduits are concentric.

39. The evaporator as claimed in claim 37 wherein the rotor is located within an enclosed housing, the housing including inlet means for supply of steam from a steam source.

40. The evaporator as claimed in claim 39 wherein the concentrate conduit has at least one inlet disposed adjacent an outer peripheral edge of the evaporator surface of the lowermost cone.

41. The evaporator as claimed in claim 40 further including at least one transfer passage extending between the outer peripheral portions of adjacent pairs of cones.

42. The evaporator as claimed in claim 41 further including at least one further cone pair which extend beyond the outer peripheral boundary of the rotor, there being means for supply of concentrated liquid from evaporator surfaces of other cones to the evaporator surfaces of said further cone pair.

43. The evaporator as claimed in claim 42 wherein there are a plurality of said further cone pair and transfer means for transfer of concentrate from one further cone pair to the next further cone pair.

44. An evaporation system for use in a farm dairy the system including an evaporator as claimed in claim 29 and a motive power source provided by a prime mover, the driving energy for individual items of equipment in the dairy including the evaporator, pumps and fans being provided by a lineshaft and clutches or from motors supplied from a generator driven by the prime mover.

45. The system as claimed in claim 44 further including a heat exchanger deriving hot water from a jacket of an internal combustion engine forming the prime mover, the other side of the heat exchanger being coupled to supply means for supply of hot water (wholly or partially) for requirements of the dairy or such other purposes as may be required.
